(19) United States
(12) Patent Application Publication
(10) Pub. No.: US 2026/0157367 A1
(43) Pub. Date: Jun. 11, 2026

(54) ABSCISIC ACID AND MALIC ACID SOLID COMPOSITIONS

(71) Applicant: Valent BioSciences LLC, Libertyville, IL (US)

(72) Inventors: Parvesh Sharma, Buffalo Grove, IL (US); Steve McArtney, Highland Park, IL (US); Yueqian Zhen, Gurnee, IL (US)

(21) Appl. No.: 19/179,146

(22) Filed: Apr. 15, 2025

Related U.S. Application Data
(60) Provisional application No. 63/634,575, filed on Apr. 16, 2024.

(51) Int. Cl. A01N 25/14; A01N 37/36; A01N 37/42; A01P 21/00

(52) U.S. Cl. CPC A01N 25/14; A01N 37/36; A01N 37/42; A01P 21/00

(57) ABSTRACT

The present invention is directed to a solid composition comprising a mixture of abscisic acid and from about 30% to about 90% w/w malic acid. The present invention is further directed to a granular composition comprising a mixture of abscisic acid and from about 80% to about 90% w/w malic acid, wherein the composition does not comprise a filler. The present invention is further directed to a method of improving stress tolerance, growth and/or yield in plants by applying an effective amount of a mixture of the present invention to the plant.

### FIELD OF THE INVENTION

The present invention is directed to a solid composition comprising a mixture of abscisic acid and from about 30% to about 90% w/w malic acid. The present invention is further directed to a granular composition comprising a mixture of abscisic acid and from about 80% to about 90% w/w malic acid, wherein the composition does not comprise a filler. The present invention is further directed to a method of improving stress tolerance, growth and/or yield in plants by applying an effective amount of a mixture of the present invention to the plant.

### BACKGROUND OF THE INVENTION

(S)-abscisic acid (“ABA”) is an endogenous plant growth regulator with many roles in growth and development. For example, ABA inhibits seed germination by antagonizing gibberellins that stimulate the germination of seeds. ABA promotes stress tolerance and maintains growth under stress conditions (see Sharp R E et al. J Exp Bot, 2004 55:2343-2351). Interestingly, several studies have shown that maintaining ‘normal’ ABA levels in well-watered plants is required to maintain shoot growth in tomato (Sharp R E et al., J Exp Bot, 2000 51:1575-1584) and Arabidopsis thaliana (LeNoble M E et al. J Exp Bot, 2004 55:237-245). Moreover, ABA is responsible for the development and maintenance of dormancy in seeds and woody plants, which when deficient in ABA often demonstrate pre-harvest sprouting of seeds due to a lack of dormancy induction.

Further, applications of ABA have also been shown to provide protection from chilling and drought, as well as to increase the red color of seedless table grapes. Examples of effective commercially available ABA formulations include ProTone™ and Contego™ (available from Valent BioSciences LLC).

Malic acid is an intermediate compound in the citric acid (TCA) cycle, and the C4 carbon fixation process of the chloroplast. In addition, malic acid is synthesized by stomatal guard cells in plant leaves and has been shown to play an important role in stomatal control; however, it is unclear whether malic acid promotes opening or closure of the stomates (Araujo W L et al., Control of stomatal aperture, Plant Signal Behav. 2011 Sep. 6 (9), 1305-1311) as there is evidence supporting each hypothesis.

Current co-application practices for ABA and malic acid include preparing separate solutions for each active ingredient and then combining them together just prior to application. U.S. Pat. No. 10,806,097B2 (“the '097 patent”) is directed to such co-application at weight ratios of ABA to malic acid from 3.3:1 to 1:33.3. However, malic acid is not stable in a liquid formulation at higher concentrations and the '097 patent fails to teach any particular concentration of ABA or malic acid in a composition.

Thus, there is a need in the art for a stable and easy to use formulation containing a mixture of ABA and malic acid.

### SUMMARY OF THE INVENTION

In one aspect, the present invention is directed to a solid composition comprising a mixture of abscisic acid and from about 30% to about 90% w/w malic acid.

In another aspect, the present invention is directed to a granular composition comprising abscisic acid and from about 80% to about 90% w/w malic acid, wherein the composition does not comprise a filler.

In another aspect, the present invention is directed to a method of improving stress tolerance in a plant comprising applying an effective amount of a composition of the present invention to the plant.

In another aspect, the present invention is directed to a method of improving growth in a plant comprising applying an effective amount of a composition of the present invention to the plant.

In another aspect, the present invention is directed to a method of improving yield in a plant comprising applying an effective amount of a composition of the present invention to the plant.

### DETAILED DESCRIPTION OF THE INVENTION

The applicant has unexpectedly discovered stable compositions containing abscisic acid and at least about 30% w/w malic acid. Applicant has further unexpectedly discovered that relatively higher concentrations of malic acid of at least about 80% w/w can create a stable granule composition without the need for a filler.

In one embodiment, the present invention is directed to a solid composition comprising a mixture of abscisic acid and from about 30% to about 90% w/w malic acid.

In a preferred embodiment, abscisic acid is present in compositions of the present invention in the form of(S)-abscisic acid and even more preferably in the form of(S)-(+) abscisic acid. In an even more preferred embodiment, abscisic acid is the abscisic acid having the CAS #21293-29-8.

In another preferred embodiment, malic acid is the malic acid having the CAS #6915-15-7.

In a preferred embodiment, the composition is in the form of a wettable powder or a granule.

In a more preferred embodiment, the composition is in the form of a granule selected from the group consisting of an extruded granule and a non-extruded granule. Non-extruded granules may be in the shape of a smooth sphere or a rough sphere wherein the sphere may be perfectly spherical or not perfectly spherical.

In another preferred embodiment, the composition comprises less than about 5% w/w water and more preferably less than about 2% w/w water and even more preferably less than about 1% w/w water. Water concentrations in compositions of the present invention are based on the amount of water as measured by the loss on drying method, the Karl Fischer method or similar.

In another preferred embodiment, the composition does not comprise a filler.

In another preferred embodiment, the abscisic acid is at a concentration from about 2% to about 9% w/w.

In another preferred embodiment, the composition of the present invention further comprise one or more excipients selected from the group consisting of fillers, binders and surfactants.

As used herein, the term “filler” refers to an inert ingredient used to increase the bulk of a solid composition. Fillers suitable for use in the present invention include, but are not limited to, sugars such as glucose, fructose, disaccharides, saccharide polymers, lactose monosaccharide polymers and the like and clays, salts, and silicas such as synthetic silicates, kaolin, dolomite, calcium carbonate, talc, bentonite clay and the like or a combination thereof.

Saccharide polymers suitable for use in the present invention include, but are not limited to, lactose, lactose monohydrate, maltose, sucrose and the like.

Hydrolyzed starches suitable for use in the present invention include, but are not limited to maltodextrin, corn syrup solids and the like.

Clays suitable for use in the present invention include, but are not limited to, kaolin, dolomite, bentonite and the like.

Salts suitable for use in the present invention include, but are not limited to, calcium chloride, sodium sulfate and the like.

Binders suitable for use in the present invention include, but are not limited to, polyvinyl alcohols, maltodextrins, alkylated vinyl pyrrolidone copolymers, cross-linked polyvinylpyrrolidones, copolymers of vinyl acetate and vinylpyrrolidone, lignosulfonates and sodium or calcium salts thereof, methyl cellulose ethers; ethyl cellulose polymers, starch, silicates and sodium or calcium salts thereof. In a preferred embodiment, binders present in compositions of the present invention are polyvinylpyrrolidones such as Agrimer™ polyvinylpyrrolidones such as Agrimer™ 15, Agrimer™ 30 and the like. Agrimer is available from Ashland.

Surfactants suitable for use in the present invention include, but are not limited to, nonionic and anionic surfactants and mixtures thereof.

Nonionic surfactants include, but are not limited to:
ethoxylated sorbitan esters such as Tween® (Tween is a registered trademark of and available from Croda Americas LLC) including Tween® 20, 21, 23, 24 and the like;
sorbitan fatty acid esters such as Span® (Span is a registered trademark of and available from Croda Americas LLC) including Span® 20, 40, 60 and 80 series and the like, Agnique® S-Maz (Agnique is a registered trademark of Cognis IP Management GMHB and is available from BASF) and Agnique® T-Maz;
alkoxylated alkyl alcohols such as Tomadol®, (Tomadol is a registered trademark of and available from Evonik Operations GMBH), Synperonic® (Synperonic is a registered trademark of and available from Croda Americas LLC), Atlox® MBA 11/8 (Atlox is a registered trademark of and available from Croda Americas LLC), Ecosurf® EH-14 (Ecosurf is a registered trademark of and available from Dow Chemical Company), TOXIMUL® 8304 (Toximul is a registered trademark of and available from Stepan Company) and Makon® TD (Makon is a registered trademark of and available from Stepan Company), fatty alcohol alkoxylates such as ECOSURF® SA-15, and Lutensol® (Lutensol is a registered trademark of and available from BASF SE), secondary alcohol alkoxylates and ethoxylates such as ECOSURF® LF-45, Tergitol® 15 S-9 (Tergitol is a registered trademark of and available from Union Carbide Corp.), Tergitol® 15 S20, Tergitol® TMN-10, ethoxylated alkylphenols such as Triton® series, X-100, X114 (Triton is a registered trademark of and available from Union Carbide Corp.), Atlox® 775, Lissapol™ PA (Lissapol is available from Croda Americas LLC), Makon® 14, and Makon® TSP-25, copolymers of ethylene oxide and propylene oxide such as Tergitol® XJ, Tergitol® L-64, Step-Flow® 26 (Step-Flow is a registered trademark of and available from Stepan Company), and Toximul® 8323, blockcopolymers of ethylene oxide and propylene oxide such as Pluronic® series (Pluronic is a registered trademark of and available from BASF Company), Agnique® BP, Synperonic® PE/F series, Atlas® G-5000 (Atlas is a registered trademark of and available from Croda Americas LLC), and Ultraric® PE ((Ultraric is a registered trademark of and available from Oxiteno S.A.) and propoxylated and ethoxylated fatty acids such as Alkest® E 100 (Alkest is a registered trademark of and available from Oxiteno S.A.);
polyoxyethylene ethers such as polyoxyl 2 cetyl ether, polyoxyl 10 cetyl ether, polyoxyl 20 cetyl ether, polyoxyl 4 lauryl ether, polyoxyl 23 lauryl ether, polyoxyl 2 oleyl ether, polyoxyl 10 oleyl ether, polyoxyl 20 oleyl ether, polyoxyl 2 stearyl ether, polyoxyl 10 stearyl ether, polyoxyl 20 stearyl ether, polyoxyl 100 stearyl ethers such as Brij® C2, Brij® C10, Brij® C20,
Brij® L4, and Brij® L23, polyoxyethylene (20) oleyl ether Brij® O20, Brij® S20 (Brij is a registered trademark of and available from Croda Americas LLC) and the like;
ethoxylated fatty amines such as Atlas® G-3780, Toximul® CA-7.5, Toximul® TA-15; ethoxylated fatty acids such as Alkamuls® (Alkamuls is a registered trademark of and available from Rhodia), Cithrol™ series (Cithrol is available from Croda Americas LLC), Myrj® series (Myrj is a registered trademark of and available from Croda Americas LLC), and Ninex® MT (Ninex is a registered trademark of and available from Stepan Company);
ethoxylated fatty esters such as Atlas® G-1086 and Agnique® ME;
ethoxylated oils such as Agnique® SBO, Atlox® 3484, Cirrasol® G-1282 (Cirrasol is a registered trademark of and available from Croda International PLC), Etocas™ 32 (Etocas I available from Croda Americas LLC), and Toximul® 8240;
fatty acids such as Atlas® G-1556;
nonionic lignosulfonates such as Stepsperse® DF-600 (Stepsperse is a registered trademark of and available from Stepan Company);
alkylpolysaccharides such as AL-2575, Multitrope™ 1620, (Multitrope is available from Croda Americas LLC), alkylpolyglucosides such as Triton® CG-50, and Agnique® PG;
polymeric surfactants such as Atlox® 4912, and Cresplus™ DP (Cresplus is available from Kanz Chemical Ind. LLC); and
silicone-based surfactants such as Silwet (Silwet is a registered trademark of and available from Momentive Performance Materials Inc.), Break-thru® (Break-thru is a registered trademark of and available from Evonik GMBH), and Xiameter™ OFX-5211 (Xiameter is a registered trademark of and available from Dow Corning Corp.); and
any mixtures of nonionic surfactants, for example Atlox® AL-3273, Atlox® 3416 and Micro-step™ H-303 (Microstep is a registered trademark of and available from Stepan Company).

In a preferred embodiment, the compositions of the present invention comprise a polyoxyethylene oleyl ether such as Brij® 020 as a nonionic surfactant.

Anionic surfactants suitable for use in the present invention include, but are not limited to:
phosphate esters such as Crodafos™, Cresplus™ 1209, Multitrope™ 1214, Triton® H-55, Stepfac™ 8175 (Stepfac is available from Stepan Company), and Agrilan® 1028 (Agrilan is a registered trademark of and available from Nouryon Chemicals International BV);
alkyldiphenyloxide disulfonate salts such as Dowfa® 3B2 (Dowfax is a registered trademark of and available from Dow Chemical Company);
alkyl sulfates such as sodium lauryl sulfate such as Stepwet® DF-95 (Stepwet is a registered trademark of and available from Stepan Company);
alkyl benzene sulfonates such as Agnique® ABS, Ninate® 60E (Ninate is a registered trademark of and available from Stepan Company) and Biosoft BIO-TERGE® AS-40 (Bio-Terge is a registered trademark of and available from Stepan Company);
sulfates and sulfonates of ethoxylated alkylphenols such as Polystep® B-27 (Polystep is a registered trademark of and available from Stepan Company), and Steol® TSP-16N (Stepol is a registered trademark of and available from Stepan Company);
sulfonates of condensed naphthalenes such as Morwet® (Morwet is a registered trademark of and available from Nouryon Chemicals International BV), Powerblox® SN (Powerblox is a registered trademark of and available from Dow Chemical Company), Agnique® NSC;
sulfonates of naphthalene and alkyl naphtha Dispersol™ F CONC, and Agnique® ANS; sulfosuccinates and derivatives such as Aerosol® OT-B (Aerosol is a registered trademark of and available from Cytec Technology Corp.), Multiwet™ (Multiwet is a registered trademark of and available from Croda America LLC), and Triton® GR-5M;
ether sulfates such as sodium laureth sulfates with varying degrees of ethhoxylations such as Steol® CS-370 (Steol is a registered trademark of and available from Stepan Company);
lignin based surfactants such as Dispersol™ SC 873, and Stepsperse® DF-200; and
polymeric surfactants such as Atlox Metasperse® (Atlox Metasperse is a registered trademark of and available from Croda International PLC), Atlox® 4913, and Zephrym® PD3315 (Zephrym is a registered trademark of and available from Croda Americas LLC).

In a preferred embodiment, the compositions of the present invention comprise an anionic surfactant selected from sulfosuccinates and derivatives thereof such as Aersosol® OT-B.

Examples of mixtures of anionic and nonionic surfactants include Atlox® 671, Atlox® 793, Atlox® 3467, Atplus® 309F (Atplus is a registered trademark of and available from Croda Americas LLC), and Toximul® DM-83.

In a preferred embodiment, the present invention is directed to a granular composition comprising abscisic acid and from about 80% to about 90% w/w malic acid, wherein the composition does not comprise a filler.

In a preferred embodiment, the malic acid is a concentration from about 85% w/w to about 90% w/w.

In one embodiment, the present invention is directed to a method of improving stress tolerance in a plant comprising applying an effective amount of a composition of the present invention to the plant.

In a preferred embodiment, the stress tolerance that is improved is an abiotic stress.

In a more preferred embodiment, the plant is subjected to drought stress. As used herein, “drought stress” refers to insufficient water availability wherein plant growth is significantly slowed as compared to those where water availability is sufficient to support optimal growth and development.

In one embodiment, the present invention is directed to a method of improving growth in a plant comprising applying an effective amount of a composition of the present invention to the plant.

In one embodiment, the present invention is directed to a method of improving yield in a plant comprising applying an effective amount of a composition of the present invention to the plant.

In another embodiment, the plant is a monocotyledonous plant or a dicotyledonous plant. In a preferred embodiment the plant is selected from the group consisting of root, corm and tuber vegetable plants, bulb vegetable plants, leafy non-brassica vegetable plants, leafy brassica vegetable plants, succulent or dried legume plants, fruiting vegetable plants, cucurbit vegetable plants, citrus fruit plants, pome fruit plants, stone fruit plants, berry and small fruit plants, tree nut plants, cereal crops, forage and fodder grasses and hay, non-grass animal feed plants, herb plants, spice plants, flower plants, bedding plants, ornamental flower plants, artichoke, asparagus, tropical fruit plants, hops, malanga, peanut, pomegranate plants, oil seed vegetable plants, tobacco plants, turf grass and watercress plant. In a more preferred embodiment, the plant is wheat, corn, rice or lettuce. In another preferred embodiment, the plant is sugarcane, a cultivar, variety or hybrid thereof.

In a preferred embodiment, the root, corm and tuber vegetable plants are selected from the group consisting of arracacha, arrowroot, Chinese artichoke, Jerusalem artichoke, garden beet, sugar beet, edible burdock, edible canna, carrot, bitter cassava, sweet cassava, celeriac, root chayote, turnip-rooted chervil, chicory, chufa, dasheen (taro), ginger, ginseng, horseradish, leren, turnip-rooted parsley, parsnip, potato, radish, oriental radish, rutabaga, salsify, black salsify, Spanish salsify, skirret, sweet potato, tanier, turmeric, turnip, yam bean, true yam, and cultivars, varieties and hybrids thereof.

In another preferred embodiment, the bulb vegetable plants are selected from the group consisting of fresh chive leaves, fresh Chinese chive leaves, bulb daylily, elegans hosta, bulb fritillaria, fritillaria leaves, bulb garlic, great-headed bulb garlic, serpent bulb garlic, kurrat, lady's leek, leek, wild leek, bulb lily, Beltsville bunching onion, bulb onion, Chinese bulb onion, fresh onion, green onion, macrostem onion, pearl onion, potato bulb onion, potato bulb, tree onion tops, Welsh onion tops, bulb shallot, fresh shallot leaves, and cultivars, varieties and hybrids thereof.

In a further embodiment, the leafy non-brassica vegetable plants are selected from the group consisting of Chinese spinach Amaranth, leafy Amaranth, arugula (roquette), cardoon, celery, Chinese celery, celtuce, chervil, Chinese spinach, edible-leaved chrysanthemum, garland chrysanthemum, corn salad, garden cress, upland cress, dandelion, dandelion leaves, sorrels (dock), endive (escarole), Florence fennel, head lettuce, leaf lettuce, orach, parsley, garden purslane, winter purslane, radicchio (red chicory), rhubarb, spinach, New Zealand spinach, vine spinach, Swiss chard, Tampala, and cultivars, varieties and hybrids thereof.

In another embodiment, the leafy brassica vegetable plants are selected from the group consisting of broccoli, Chinese broccoli (gai lon), broccoli rabe (rapini), Brussels sprouts, cabbage, Chinese cabbage (bok choy), Chinese napa cabbage, Chinese mustard cabbage (gai choy), cauliflower, cavolo broccoli, collards, kale, kohlrabi, mizuna, mustard greens, mustard spinach, rape greens, turnip greens and cultivars, varieties and hybrids thereof. In yet another embodiment, the succulent or dried vegetable legumes are selected from the group consisting of Lupinus beans, Phaseolus beans, Vigna beans, broad beans (fava), chickpea (garbanzo), guar, jackbean, lablab bean, lentil, Pisum peas, pigeon pea, soybean, immature seed soybean, sword bean, peanut, and cultivars, varieties and hybrids thereof. In a preferred embodiment, the Lupinus beans include grain lupin, sweet lupin, white lupin, white sweet lupin, and hybrids thereof. In another preferred embodiment, the Phaseolus beans include field bean, kidney bean, lima bean, navy bean, pinto bean, runner bean, snap bean, tepary bean, wax bean, and hybrids thereof. In yet another preferred embodiment, the Vigna beans include adzuki bean, asparagus bean, blackeyed bean, catjang, Chinese longbean, cowpea, Crowder pea, moth bean, mung bean, rice bean, southern pea, urd bean, yardlong bean, and hybrids thereof. In another embodiment, the Pisum peas include dwarf pea, edible-podded pea, English pea, field pea, garden pea, green pea, snow pea, sugar snap pea, and hybrids thereof. In a preferred embodiment, the dried vegetable legume is soybean. In a more preferred embodiment, the dried vegetable legume is genetically modified soybean.

In a further embodiment, the fruiting vegetable plants are selected from the group consisting of bush tomato, cocona, currant tomato, garden huckleberry, goji berry, groundcherry, martynia, naranjilla, okra, pea eggplant, pepino, bell peppers, non-bell peppers, roselle, eggplant, scarlet eggplant, African eggplant, sunberry, tomatillo, tomato, tree tomato, and cultivars, varieties and hybrids thereof. In a preferred embodiment, the peppers include bell peppers, chili pepper, cooking pepper, pimento, sweet peppers, and hybrids thereof.

In an embodiment, the cucurbit vegetable plants are selected from the group consisting of Chayote, Chayote fruit, waxgourd (Chinese preserving melon), citron melon, cucumber, gherkin, edible gourds, Momordica species, muskmelons, pumpkins, summer squashes, winter squashes, watermelon, and cultivars, varieties and hybrids thereof. In a preferred embodiment, edible gourds include hyotan, cucuzza, hechima, Chinese okra, and hybrids thereof. In another preferred embodiment, the Momordica vegetables include balsam apple, balsam pear, bittermelon, Chinese cucumber, and hybrids thereof. In another preferred embodiment, the muskmelon include true cantaloupe, cantaloupe, casaba, crenshaw melon, golden pershaw melon, honeydew melon, honey balls, mango melon, Persian melon, pineapple melon, Santa Claus melon, snake melon, and hybrids thereof. In yet another preferred embodiment, the summer squash include crookneck squash, scallop squash, straightneck squash, vegetable marrow, zucchini, and hybrids thereof. In a further preferred embodiment, the winter squash includes butternut squash, calabaza, hubbard squash, acorn squash, spaghetti squash, and hybrids thereof.

In another embodiment, the citrus fruit plants are selected from the group consisting of limes, calamondin, citron, grapefruit, Japanese summer grapefruit, kumquat, lemons, Mediterranean mandarin, sour orange, sweet orange, pummelo, Satsuma mandarin, tachibana orange, tangelo, mandarin tangerine, tangor, trifoliate orange, uniq fruit, and cultivars, varieties and hybrids thereof. In a preferred embodiment, the limes are selected from the group consisting of Australian desert lime, Australian finger lime, Australian round lime, Brown River finger lime, mount white lime, New Guinea wild lime, sweet lime, Russell River lime, Tahiti lime, and hybrids thereof.

In an embodiment, the pome fruit plants are selected from the group consisting of apple, azarole, crabapple, loquat, mayhaw, medlar, pear, Asian pear, quince, Chinese quince, Japanese quince, tejocote, and cultivars, varieties and hybrids thereof.

In another embodiment, the stone fruit plants are selected from the group consisting of apricot, sweet cherry, tart cherry, nectarine, peach, plum, Chicksaw plum, Damson plum, Japanese plum, plumcot, fresh prune, and cultivars, varieties and hybrids thereof.

In a further embodiment, the berries and small fruit plants are selected from the group consisting of Amur river grape, aronia berry, bayberry, bearberry, bilberry, blackberry, blueberry, lowbush blueberry, highbush blueberry, buffalo currant, buffaloberry, che, Chilean guava, chokecherry, cloudberry, cranberry, highbush cranberry, black currant, red currant, elderberry, European barberry, gooseberry, grape, edible honeysuckle, huckleberry, jostaberry, Juneberry (Saskatoon berry), lingonberry, maypop, mountain pepper berries, mulberry, muntries, native currant, partridgeberry, phalsa, pincherry, black raspberry, red raspberry, riberry, salal, sea buckthorn, serviceberry, strawberry, wild raspberry, and cultivars, varieties and hybrids thereof. In a preferred embodiment, the blackberries include Andean blackberry, arctic blackberry, bingleberry, black satin berry, boysenberry, brombeere, California blackberry, Chesterberry, Cherokee blackberry, Cheyenne blackberry, common blackberry, coryberry, darrowberry, dewberry, Dirksen thornless berry, evergreen blackberry, Himalayaberry, hullberry, lavacaberry, loganberry, lowberry, Lucreliaberry, mammoth blackberry, marionberry, mora, mures deronce, nectarberry, Northern dewberry, olallieberry, Oregon evergreen berry, phenomenalberry, rangeberry, ravenberry, rossberry, Shawnee blackberry, Southern dewberry, tayberry, youngberry, zarzamora, and hybrids thereof.

In another embodiment, the tree nut plants are selected from the group consisting of almond, beech nut, Brazil nut, Brazilian pine, bunya, butternut, bur oak, Cajou nut, candlenut, cashew, chestnut, chinquapin, coconut, coquito nut, dika nut, gingko, Guiana chestnut, hazelnut (filbert), heartnut, hickory nut, Japanese horse-chestnut, macadamia nut, mongongo nut, monkey-pot, monkey puzzule nut, Okari nut, Pachira nut, peach palm nut, pecan, Pili nut, pistachio, Sapucaia nut, tropical almond, black walnut, English walnut, yellowhorn, and cultivars, varieties and hybrids thereof.

In a further embodiment, the cereal grains are selected from the group consisting of barley, buckwheat, pearl millet, proso millet, oats, corn, field corn, sweet corn, seed corn, popcorn, rice, rye, sorghum (milo), sorghum species, grain sorghum, sudangrass (seed), teosinte, triticale, wheat, wild rice, and cultivars, varieties and hybrids thereof. In a preferred embodiment, the cereal grain is selected from the group consisting of wheat, rice and corn. In a more preferred embodiment, the cereal grain is genetically modified corn.

In yet another embodiment, the grass forage, fodder and hay are selected from the group consisting of grasses that are members of the Gramineae family and those species included in the cereal grains group, pasture and range grasses, and grasses grown for hay or silage. In further embodiments, the Gramineae grasses may be green or cured.

In an embodiment, the non-grass animal feeds are selected from the group consisting of alfalfa, velvet bean, trifolium clover, melilotus clover, kudzu, lespedeza, lupin, sainfoin, trefoil, vetch, crown vetch, milk vetch, and cultivars, varieties and hybrids thereof.

In another embodiment, the herbs and spice plants are selected from the group consisting of allspice, angelica, anise, anise seed, star anise, annatto seed, balm, basil, borage, burnet, chamomile, caper buds, caraway, black caraway, cardamom, cassia bark, cassia buds, catnip, celery seed, chervil, chive, Chinese chive, cinnamon, clary, clove buds, coriander leaf, coriander seed, costmary, culantro leaves, culantro seed, cilantro leaves, cilantro seed, cumin, dillweed, dill seed, fennel, common fennel, Florence fennel seed, fenugreek, grains of paradise, horehound, hyssop, juniper berry, lavender, lemongrass, leaf lovage, seed lovage, mace, marigold, marjoram, mint, mustard seed, nasturtium, nutmeg, parsley, pennyroyal, black pepper, white pepper, poppy seed, rosemary, rue, saffron, sage, summer savory, winter savory, sweet bay, tansy, tarragon, thyme, vanilla, wintergreen, woodruff, wormwood, and cultivars, varieties and hybrids thereof.

In a preferred embodiment, the mints are selected from the group consisting of spearmint, peppermint, and hybrids thereof.

In yet another embodiment, artichokes are selected from the group consisting of Chinese artichoke, Jerusalem artichoke, and cultivars, varieties and hybrids thereof.

In an embodiment, the tropical fruit plants are selected from the group consisting of anonna, avocado, fuzzy kiwifruit, hardy kiwifruit, banana, plantain, caimito, carambola (star fruit), guava, longan, sapodilla, papaya, passion fruit, mango, lychee, jackfruit, dragon fruit, mamey sapote, coconut cherimoya, canistrel, monstera, wax jambu, pomegranate, rambutan, pulasan, Pakistani mulberry, langsat, chempedak, durian, fig pineapple, jaboticaba, mountain apples, and cultivars, varieties and hybrids thereof.

In a further embodiment, the oil seed vegetable plants are selected from the group consisting of borage, calendula, castor oil plant, tallowtree, cottonseed, crambe, cuphea, echium, euphorbia, evening primrose, flax seed, gold of pleasure, hare's ear, mustard, jojoba, lesquerella, lunaria, meadowfoam, milkweed, niger seed, oil radish, poppy seed, rosehip, sesame, stokes aster, sweet rocket, tallowwood, tea oil plant, vermonia, canola, or oil rapeseed, safflower, sunflower, and cultivars, varieties and hybrids thereof.

In another embodiment, the plant is subjected to drought stress. As used herein, “drought stress” refers to watering conditions wherein plant growth is significantly slowed as compared to those where water availability is sufficient to support optimal growth and development.

In a preferred embodiment, ABA and malic acid is applied prior to or during the advent of abiotic stress. When the intended stress is drought, application of ABA and malic acid occurs prior to or during drought stress. Application prior to drought allows for banking of soil water. By conserving soil water plants can extend survival and growth during critical growth stages, when yield losses due to water stress are higher.

Application of the mixture of the present invention may occur at any time from planting to just prior to harvest of the plant. In a preferred embodiment, application occurs from about 8 weeks prior to harvest to about 2 weeks prior to harvest, most preferably at about 8 weeks prior to harvest.

As used herein, “effective amount” refers to the amount of the ABA and/or malic acid that will improve growth, drought stress tolerance, and/or yield. The “effective amount” will vary depending on the ABA and malic acid concentrations, the plant species or variety being treated, the severity of the stress, the result desired, and the life stage of the plants, among other factors. Thus, it is not always possible to specify an exact “effective amount.” However, an appropriate “effective amount” in any individual case may be determined by one of ordinary skill in the art.

As used herein, “improving” means that the plant has more of the quality than the plant would have had it if it had not been treated by methods of the present invention.

As used herein, “yield” refers to any measurable mass of the plant including, but not limited to, total biomass of the plant and the mass of commercially viable products of the plant.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a,” “an” and “the” are intended to include the plural as well as the singular, unless the context clearly indicates otherwise.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

### EXAMPLES

Brij® 020 is polyoxyethylene (20) oleyl ether and has CAS #9004-98-2.

Agrimer™ 30 is polyvinylpyyrolidone and has CAS #9003-39-8.

Aerosol® OT-B is a mixture of dioctyl sulfosuccinate sodium salt (having CAS #577-11-7) and sodium benzoate.

Ultrazine is sodium lignosulfonate and has CAS #8061-51-6 and is available from Borregaard Lignotech.

### Example 1. Aqueous Abscisic Acid and Malic Acid Formulations

An aqueous formulation containing 1.9% abscisic acid and 20.9% malic acid in water was formulated and stored for 2 weeks at 54 degrees Celsius. Following storage, the aqueous formulation was analyzed via HPLC to determine the degradation of abscisic acid and malic acid. Following storage, abscisic acid degraded by 11% to 1.7% of the formulation. Malic acid degraded by 6.2% to 19.6% of the formulation. Thus, aqueous formulations of abscisic acid and malic acid containing at least 20.9% malic acid are unstable.

### Example 2. Non-Aqueous Liquid Abscisic Acid and Malic Acid Formulations

Two non-aqueous liquid formulations containing 2.2% abscisic acid and 19.7% and 20.4% malic acid in either propylene glycol or polyethylene glycol 200, respectively, were formulated. Following storage, the aqueous formulation was analyzed via HPLC to determine the degradation of abscisic acid and malic acid. Following storage, abscisic acid degraded in propylene glycol by 4.5% to 2.1% of the formulation. Malic acid degraded by 88% in propylene glycol to 2.4% of the formulation. Abscisic acid degraded in polyethylene glycol by 9% to 2.0% of the formulation. Malic acid degraded by 67% in polyethylene glycol 200 to 6.8% of the formulation. Thus, non-aqueous liquid formulations of abscisic acid and malic acid containing at least 19.7% malic acid are unstable.

### Example 3. Liquid Mixture Abscisic Acid and Malic Acid Formulations

Two non-aqueous/aqueous mixture liquid formulations containing 2.7% and 2.9% abscisic acid and 26.6% and 27.2% malic acid in either a mixture of water and propylene glycol or a mixture of water and polyethylene glycol 200, respectively, were formulated. Following storage, the aqueous formulation was analyzed via HPLC to determine the degradation of abscisic acid and malic acid. Following storage, abscisic acid degraded in propylene glycol and water by 7.4% to 2.5% of the formulation. Malic acid degraded by 56% in propylene glycol and water to 11.6% of the formulation. Abscisic acid degraded in polyethylene glycol 200 and water by 10% to 2.6% of the formulation. Malic acid degraded by 26% in polyethylene glycol 200 and water to 20% of the formulation. Thus, non-aqueous/aqueous mixture liquid formulations of abscisic acid and malic acid containing at least 26.6% malic acid are unstable.

### Example 4. Stable Granular Compositions

### Method

A wet mass comprising 8.6% w/w (8% to 9% w/w) abscisic acid and 86% w/w (83% to 89% w/w) malic acid, 0.25% w/w (0.1% to 0.5% w/w) Brij® 020, 2% w/w (0.8% to 2.5% w/w) Agrimer® 30, 1.5% to 2.2% w/w (1.0% to 4.4% w/w) Aerosol® OT-B and water. Specifically, abscisic acid and malic acid dry powders were blended in a bag. Following blending a solution containing all excipients in water was added dropwise to the blend to create a wet mass. The wet mass was extruded and dried to create stable granules, which were stored at 5 degrees Celsius or 54 degrees Celsius for 4 weeks.

### Results

Following storage, the granules described above were found to have good attrition resistance, fast dissolution and were non-dusty upon tumbling. Further, the granules were dissolved in water and assayed for ABA and malic acid content. The granules maintained at least 95% each of the starting ABA and malic acid content following accelerated storage conditions.

### Example 5. Stable Granular Compositions

### Method

A wet mass comprising 8.8% w/w abscisic acid and 87.8% w/w malic acid, 0.63% w/w Brij® 020, 1.52% w/w Agrimer® 30 and water was formulated by the method described in Example 1, above. The wet mass was extruded and dried to create stable granules, which were stored at 5 degrees Celsius or 54 degrees Celsius for 2 weeks.

### Results

Following storage, the granules described above were found to have good attrition resistance, fast dissolution and were non-dusty upon tumbling. Further, the granules were dissolved in water and assayed for ABA and malic acid content. The granules maintained at least 95% each of the starting ABA and malic acid content following accelerated storage conditions.

### Example 6. Stable Granular Compositions

### Method

A wet mass comprising 8.7% w/w abscisic acid and 87.06% w/w malic acid, 0.2% w/w Brij® 020, 1.463% w/w Agrimer® 30, 1.349% Aerosol® OT-B and water and isopropyl alcohol at a 1:1 ratio was formulated by the method described in Example 1, above. The wet mass was extruded and dried to create stable granules, which were stored at 5 degrees Celsius or 54 degrees Celsius for 2 weeks.

### Results

Following storage, the granules described above were found to have good attrition resistance, fast dissolution and were non-dusty upon tumbling. Further, the granules were dissolved in water and assayed for ABA and malic acid content. The granules maintained at least 95% each of the starting ABA and malic acid content following accelerated storage conditions.

### Example 7. Stable Granular Compositions

### Method

Two separate wet masses were formulated by the method described in Example 1, above. Content of these wet masses after drying can be found in Table 1, below. The wet mass was extruded and dried to create stable granules, which were stored at 5 degrees Celsius or 54 degrees Celsius for 2 weeks.

TABLE 1

| Composition | #1 | #2 |
|---|---|---|
| Abscisic acid | 5.016% | 8.8% |
| Malic acid | 50.16% | 88% |
| Agrimer ® 30 | 0.609% | 1.5% |
| Brij ® 20 | 0.575% | 0.26% |
| Aerosol ® OT-B | 1.26% | 1.44% |
| Ultrazine | 0.05% | — |
| Lactose monohydrate | 42.33% | — |

### Results

Following storage, the granules described above were found to have good attrition resistance, fast dissolution and were non-dusty upon tumbling. Further, the granules were dissolved in water and assayed for ABA and malic acid content. The granules maintained at least 95% each of the starting ABA and malic acid content following accelerated storage conditions.

### Example 8. Increased Yield in Wheat Plants Under Drought Stress

Wheat plants were each treated with a granular composition comprising 8.7% w/w abscisic acid and 87% w/w malic acid. The experiment consisted of a completely randomized design and consisted of 6 replicates. The granular composition was applied at a rate of 4 grams S-ABA and 40 grams of malic acid per hectare (45 grams of the granular composition) at either stage A (flag leaf to boot stage), stage B (middle of heading stage), stage C (beginning of flowering to full flowering stage) or stage D (watery ripe to early milk stage) in a spray volume of 200 L per hectare. Water was withheld for three days after treatment and kept well-watered for next four days. At harvest the grain yield at 15% grain moisture content and weight of one thousand grains (“thousand grain weight”) were calculated. The protein concentration was measured from a sample of harvested grains. Results can be seen in Table 1, below.

TABLE 1

| | Yield at 15% | | |
|---|---|---|---|
| | moisture | Thousand Grain | Protein |
| Application Timing | (T/ha) | Weight (g) | Content (%) |
| Untreated Control | 6.39 b* | 42.14 b | 16.96 b |
| Stage A | 7.38 a | 44.41 a | 17.94 a |
| Stage B | 7.62 a | 43.68 a | 17.59 a |
| Stage C | 7.33 a | 43.37 a | 18.01 a |
| Stage D | 7.49 a | 44.10 a | 17.68 a |

*Data points not sharing the same letter indicate a statistically significant difference between the two data points.

As seen in Table 1, the application of the ABA and malic acid granular composition demonstrated increased yield and protein content as compared to the untreated control. Thus, solid compositions of the present invention are capable of providing effective drought stress tolerance.

### Example 9. Increased Yield in Barley Plants Under Drought Stress

Barley plants were each treated with a granular composition comprising 8.7% w/w abscisic acid and 87% w/w malic acid. The experiment consisted of a completely randomized design and consisted of 6 replicates. The granular composition was applied at a rate of 4 grams S-ABA and 40 grams of malic acid per hectare (45 grams of the granular composition) at either stage A (flag leaf to boot stage), stage B (middle of heading stage), stage C (beginning of flowering to full flowering stage) or stage D (watery ripe to early milk stage) in a spray volume of 200 L per hectare. Water was withheld for three days after treatment and kept well-watered for next four days. At harvest the grain yield at 15% grain moisture content and thousand grain weight were calculated. The protein concentration was measured from a sample of harvested grains. Results can be seen in Table 2, below.

TABLE 2

| | Yield at 15% | | |
|---|---|---|---|
| | moisture | Thousand Grain | Protein |
| Application Timing | (T/ha) | Weight (g) | Content (%) |
| Untreated Control | 6.65 c | 36.60 b | 15.99 |
| Stage A | 6.91 bc | 38.30 a | 16.56 |
| Stage B | 6.85 bc | 38.29 a | 16.46 |
| Stage C | 7.13 b | 38.75 a | 16.62 |
| Stage D | 7.04 b | 38.65 a | 16.28 |

*Data points not sharing the same letter indicate a statistically significant difference between the two data points.

As seen in Table 2, the application of the ABA and malic acid granular composition demonstrated increased yield and protein content as compared to the untreated control. Thus, solid compositions of the present invention are capable of providing effective drought stress tolerance.

### Example 10. Increased Yield in Soybean Plants Under Drought Stress

Soybean plants were each treated with a granular composition comprising 8.7% w/w abscisic acid and 87% w/w malic acid. The experiment consisted of a completely randomized design and consisted of 6 replicates. The granular composition was applied at a rate of 1) 0.5 grams S-ABA and 5 grams of malic acid per hectare, 2) 1.0 grams S-ABA and 10 grams of malic acid per hectare, 3) 2 grams S-ABA and 20 grams of malic acid per hectare, 4) 4 grams S-ABA and 40 grams of malic acid per hectare and 5) 8 grams S-ABA and 80 grams of malic acid per hectare at the R4 (full pod) to R5 (beginning seed) stage in a spray volume of 150 L per hectare. Water was withheld for three days after treatment and kept well-watered for next four days. Each application rate was repeated at nine different locations in Brazil including Ponta Grossa, Primavera do Leste, Sorriso, Formosa and Sorocaba. At harvest the yield, number of pods per plant and thousand grain weight were calculated. Results can be seen in Table 3, below.

TABLE 3

| Application Rates | Yield | # of pods/ | Thousand Grain |
|---|---|---|---|
| (g/ha) | (kg/ha) | plant | Weight (g) |
| Untreated Control | 3766 | 53.3 | 146.8 |
| 0.5 ABA | 3793 | 58.8 | 146.9 |
| 5 Malic acid | | | |
| 1 ABA | 3931 | 59.9 | 148.2 |
| 10 Malic acid | | | |
| 2 ABA | 4032 | 58.7 | 149.1 |
| 20 Malic acid | | | |
| 4 ABA | 3871 | 59.1 | 149.1 |
| 40 Malic acid | | | |
| 8 ABA | 3828 | 59.7 | 149.8 |
| 80 Malic acid | | | |

As seen in Table 3, the application of the ABA and malic acid granular composition demonstrated increased yield as compared to the untreated control. Thus, solid compositions of the present invention are capable of providing effective drought stress tolerance.

### Example 11. Increased Yield in Corn Plants Under Drought Stress

Corn plants were each treated with a granular composition comprising 8.7% w/w abscisic acid and 87% w/w malic acid. The experiment consisted of a completely randomized design and consisted of 6 replicates. The granular composition was applied at a rate of 1) 0.5 grams S-ABA and 5 grams of malic acid per hectare, 2) 1.0 grams S-ABA and 10 grams of malic acid per hectare, 3) 2 grams S-ABA and 20 grams of malic acid per hectare, 4) 4 grams S-ABA and 40 grams of malic acid per hectare and 5) 8 grams S-ABA and 80 grams of malic acid per hectare at the R2 (blister) to R3 (milk) stage in a spray volume of 150 L per hectare. Water was withheld for three days after treatment and kept well-watered for next four days. Each application rate was repeated at four different locations in Brazil including Formosa, Itaara, Lavras and Ponta Grossa. At harvest the yield, grains per row and thousand grain weight were calculated. Results can be seen in Table 4, below.

TABLE 4

| Application Rates | Yield | # of | Thousand Grain |
|---|---|---|---|
| (g/ha) | (kg/ha) | grains/row | Weight (g) |
| Untreated Control | 126.7 | 33.7 | 286.1 |
| 0.5 ABA | 126.4 | 33.9 | 288.4 |
| 5 Malic acid | | | |
| 1 ABA | 126.0 | 33.7 | 293.4 |
| 10 Malic acid | | | |
| 2 ABA | 131.9 | 34.1 | 293.9 |
| 20 Malic acid | | | |
| 4 ABA | 133.0 | 33.9 | 295.4 |
| 40 Malic acid | | | |
| 8 ABA | 133.8 | 35.0 | 294.6 |
| 80 Malic acid | | | |

As seen in Table 4, the application of the ABA and malic acid granular composition demonstrated increased yield as compared to the untreated control. Thus, solid compositions of the present invention are capable of providing effective drought stress tolerance.

### Example 12. Increased Yield in Rice Plants Under Drought Stress

Rice plants were each treated with a granular composition comprising 8.7% w/w abscisic acid and 87% w/w malic acid. The experiment consisted of a completely randomized design and consisted of 4 replicates. The granular composition was applied at a rate of 1) 2.175 grams S-ABA and 21.75 grams of malic acid per hectare, 2) 4.35 grams S-ABA and 43.5 grams of malic acid per hectare, 3) 6.525 grams S-ABA and 65.25 grams of malic acid per hectare and 4) 8.7 grams S-ABA and 87 grams of malic acid per hectare at the panicle emergence stage in a spray volume of 150 L per hectare. Water was withheld for three days after treatment and kept well-watered for next four days. The study took place in Memari, West Bengal, India. At harvest the yield and thousand grain weight were calculated. Results can be seen in Table 5, below.

TABLE 5

| Application Rates | Yield | Thousand Grain |
|---|---|---|
| (g/ha) | (kg/ha) | Weight (g) |
| Untreated Control | 6.530 | 21.63 |
| 2.175 ABA | 6.794 | 22.66 |
| 21.75 Malic acid | | |
| 4.35 ABA | 7.095 | 22.61 |
| 43.5 Malic acid | | |
| 6.525 ABA | 7.392 | 23.56 |
| 65.25 Malic acid | | |
| 8.7 ABA | 7.399 | 23.57 |
| 87 Malic acid | | |

As seen in Table 5, the application of the ABA and malic acid granular composition demonstrated increased yield as compared to the untreated control. Thus, solid compositions of the present invention are capable of providing effective drought stress tolerance.

What is claimed is:

1. A solid composition comprising a mixture of abscisic acid and from about 30% to about 90% w/w malic acid, wherein w/w denotes weight by total weight of the composition.

2. The composition of claim 1, wherein the composition is a wettable powder.

3. The composition of claim 1, wherein the composition is a granule.

4. The composition of claim 1, wherein the composition comprises less than about 5% w/w water.

5. The composition of claim 1, wherein the composition does not comprise a filler.

6. The composition of claim 1, wherein abscisic acid is at a concentration from about 2% to about 9% w/w.

7. The composition of claim 1, further comprising one or more excipients selected from the group consisting of fillers, binders and surfactants.

8. The composition of claim 7, wherein the fillers are selected from the group consisting of sugars, clays and salts.

9. The composition of claim 8, wherein the sugars are selected from the group consisting of glucose, fructose, lactose, lactose monohydrate, maltose, sucrose, maltodextrin and corn syrup solids.

10. The composition of claim 8, wherein the clays are selected from the group consisting of kaolin, bentonite and dolomite.

11. The composition of claim 8, wherein the salts are selected from the group consisting of calcium chloride and sodium sulfate.

12. The composition of claim 7, wherein the binders are selected from the group consisting of polyvinylpyrrolidone and a lignosulfonate.

13. The composition of claim 7, wherein the surfactants are selected from the group consisting of ethoxylated sorbitan esters, sorbitan fatty acid esters, alkoxylated alkyl alcohols, polyoxyethylene ethers, ethoxylated fatty amines, ethoxylated fatty acids, ethoxylated fatty esters, ethoxylated oils, fatty acids, nonionic lignosulfonates, alkylpolysaccharides, silicone-based surfactants, phosphate esters, alkyldiphenyloxide disulfonate salts, alkyl sulfates, alkyl benzene sulfonates, sulfates and sulfonates of ethoxylated alkylphenols, sulfonates of condensed naphthalenes, sulfonates of naphthalene and alkyl naphtha, sulfosuccinates and derivatives thereof, ether sulfates, lignin based surfactants and polymeric surfactants.

14. The composition of claim 13, wherein the surfactant is a polyoxyethylene oleyl ether.

15. The composition of claim 14, wherein the surfactant is polyoxyethylene (20) oleyl ether.

16. A granular composition comprising abscisic acid and from about 80% to about 90% w/w malic acid, wherein the composition does not comprise a filler and wherein w/w denotes weight by total weight of the composition.

17. The composition of claim 16 wherein abscisic acid is at a concentration from about 2% to about 9% w/w.

18. A method of improving stress tolerance in a plant comprising applying an effective amount of the composition of claim 1 to the plant.

19. A method of improving growth of a plant comprising applying an effective amount of the composition of claim 1 to the plant.

20. A method of improving yield of a plant comprising applying an effective amount of the composition of claim 1 to the plant.
